(19) United States
(12) Patent Application Publication
(10) Pub. No.: US 2008/0255835 A1
(43) Pub. Date: Oct. 16, 2008

(54) USER DIRECTED ADAPTATION OF SPOKEN LANGUAGE GRAMMER

(75) Inventors: David Ollason, Seattle, WA (US); Tal Saraf, Seattle, WA (US); Michelle Spina, Winchester, MA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/733,695

(22) Filed: Apr. 10, 2007

(51) Int. Cl. G10L 15/00

(52) U.S. Cl. 704/231

(57) ABSTRACT

A method and system for interacting with a speech recognition system. A lattice of candidate words is displayed. The lattice of candidate words may include the output of a speech recognizer. Candidate words representing temporally serial utterances may be directly joined in the lattice. A path through the lattice represents a selection of one or more candidate words interpreting one or more corresponding utterances. An interface allows a user to select a path in the lattice. A selection of the path in the lattice may be received and the selection may be stored. The selection may be provided as positive feedback to the speech recognizer.

### BACKGROUND

Generally, speech recognition systems analyze audio waveforms associated with human speech and convert recognized waveforms to textual words. While such speech recognition systems have seen improvement in accuracy; the textual output still often requires correction by a human user.

Applications which require broad and generic, dictation-style language models to adequately capture the large variety of possible user input often suffer from lower recognition accuracies as compared to applications that are able to utilize focused, domain specific models. Generally, generic models may be improved by training. For example, training, in the form of comparing known audio input with known spoken words, may be used to adapt the models to nuances of these interactions, but identifying the known spoken words in speech recognition systems may be difficult.

Traditionally, speech recognition systems may be trained by assuming that example recognized text that passes defined heuristics correctly represents what was spoken. This approach generally does not account for speech recognition errors that pass the defined heuristics, as there may not be an effective way for the user to correct errors made by the recognition system. Furthermore, it may be that these false positives have the greatest impact on system performance if they go uncorrected and are included in the adaptation process.

For correcting recognized speech, traditional speech recognition systems have provided a human user with an n-best list of possibly correct textual words. For example, the user may click on a word of recognized speech and be presented with a list of five other words that are possible matches for the corresponding speech. The user may select one of the five or, perhaps, may substitute the recognized word with a new one.

Where the user interacts with the speech recognizer in a voice-only channel, the n-best list may contain only the single best possibly correct word. For example, a user may interact with a voice attendant telephone application, such as with an Interactive Voice Response (IVR) system. The user may speak the name of the person she is calling, for example, the user may say “Mike Elliot.” The speech recognition system may match this name with names in a database, but because “Mike Elliot” sounds similar to “Michael Lott,” the IVR may play a confirmation prompt associated with the most likely match. For example, the IVR may prompt the user, “did you say Michael Lott?” Following the prompt, the IVR may recognize the expected yes or no response from the user, so that the call may be routed accordingly.

Such n-best processes for correcting recognized speech may have limited effectiveness. Generally, they are most effective where there are few likely matches and where single words are involved. Consider a phase of five words where each word has three likely matches. The n-best list would include an unwieldy 243 phrase variations. Because similar sounding words are used, the user may have difficulty in sensing the correct words and filtering out the phrases with incorrect words.

### SUMMARY

A method for interacting with a speech recognition system is disclosed. A lattice of candidate words may be displayed. The lattice of candidate words may include the output of a speech recognizer. As an example, the lattice of candidate words may include a first candidate word corresponding to a first utterance received by the speech recognizer. Also for example, the first candidate word may be joined in the lattice to a second candidate word and joined in the lattice to a third candidate word. The second and third candidate words may each correspond to a second utterance received by the speech recognizer. The lattice may be received in an instant messaging protocol.

A path may include at least one of the candidate words. A selection of the path in the lattice may be received and the selection may be stored. In some embodiments, if the selected path includes the second candidate word, the third candidate word may be cleared from the lattice. The selection may be provided as positive feedback to the speech recognizer.

A user viewing the lattice should be able to identify a path representing a most likely interpretation of a series of utterances much more quickly and easily that a user viewing a list of candidate phrases in which items in the list may often vary only minimally from other items in the list. The lattice presentation may facilitate a more natural user interaction with a speech recognition system.

A speech recognition system is also disclosed. The speech recognition system may include a user interface and a datastore. The user interface may be adapted to display a graphical representation of a lattice of candidate words and to receive a selection of a path in the lattice. The datastore may be adapted to store the selection.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 depicts an example operating environment;

FIG. 2 depicts an example speech recognition system;

FIGS. 3A, B, C depict an example lattice and example paths; and

FIG. 4 is a process flow diagram for interacting with a speech recognition system.

### DETAILED DESCRIPTION

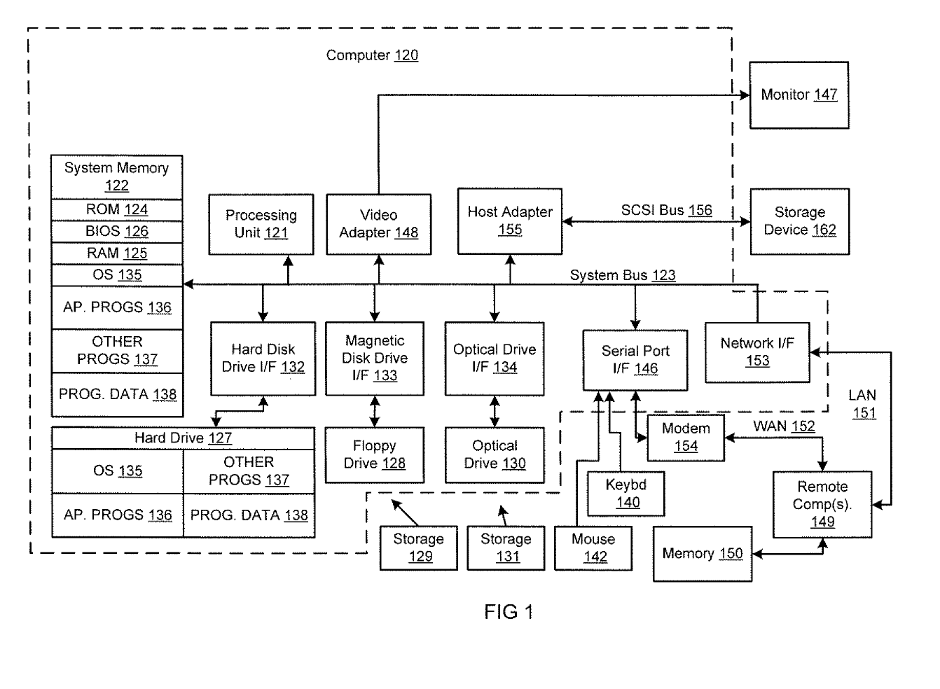

Numerous embodiments of the present invention may execute on a computer. FIG. 1 and the following discussion are intended to provide a brief general description of a suitable computing environment in which the invention may be implemented. Although not required, the invention will be described in the general context of computer executable instructions, such as program modules, being executed by a computer, such as a client workstation or a server. Generally, program modules include routines, programs, objects, components, data structures and the like that perform particular tasks or implement particular abstract data types. Moreover, those skilled in the art will appreciate that the invention may be practiced with other computer system configurations, including hand held devices, multi processor systems, microprocessor based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an example general purpose computing system includes a conventional personal computer 120 or the like, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. The system memory 121 may include read only memory (ROM) 124 and random access memory (RAM) 125. A basic input/output system 126 (BIOS), containing the basic routines that help to transfer information between elements within the personal computer 120, such as during start up, is stored in ROM 124. The personal computer 120 may further include a hard disk drive 127 for reading from and writing to a hard disk, not shown, a magnetic disk drive 128 for reading from or writing to a removable magnetic disk 129, and an optical disk drive 130 for reading from or writing to a removable optical disk 131 such as a CD ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer readable media provide non volatile storage of computer readable instructions, data structures, program modules and other data for the personal computer 120. Although the example environment described herein employs a hard disk, a removable magnetic disk 129 and a removable optical disk 131, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs) and the like may also be used in the example operating environment.

A number of program modules may be stored on the hard disk, magnetic disk 129, optical disk 131, ROM 124 or RAM 125, including an operating system 135, one or more application programs 136, other program modules 137 and program data 138. A user may enter commands and information into the personal computer 120 through input devices such as a keyboard 140 and pointing device 142. Other input devices (not shown) may include a microphone, joystick, game pad, satellite disk, scanner or the like. These and other input devices are often connected to the processing unit 121 through a serial port interface 146 that is coupled to the system bus, but may be connected by other interfaces, such as a parallel port, game port or universal serial bus (USB). A monitor 147 or other type of display device is also connected to the system bus 123 via an interface, such as a video adapter 148. In addition to the monitor 147, personal computers typically include other peripheral output devices (not shown), such as speakers and printers. The example system of FIG. 1 also includes a host adapter 155, Small Computer System Interface (SCSI) bus 156, and an external storage device 162 connected to the SCSI bus 156.

The personal computer 120 may operate in a networked environment using logical connections to one or more remote computers, such as a remote computer 149. The remote computer 149 may be another personal computer, a server, a router, a network PC, a peer device or other common network node, and typically includes many or all of the elements described above relative to the personal computer 120, although only a memory storage device 150 has been illustrated in FIG. 1. The logical connections depicted in FIG. 1 include a local area network (LAN) 151 and a wide area network (WAN) 152. Such networking environments are commonplace in offices, enterprise wide computer networks, intranets and the Internet.

When used in a LAN networking environment, the personal computer 120 is connected to the LAN 151 through a network interface or adapter 153. When used in a WAN networking environment, the personal computer 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer 120, or portions thereof, may be stored in the remote memory storage device. It will be appreciated that the network connections shown are example and other means of establishing a communications link between the computers may be used. Moreover, while it is envisioned that numerous embodiments of the present invention are particularly well-suited for computerized systems, nothing in this document is intended to limit the invention to such embodiments.

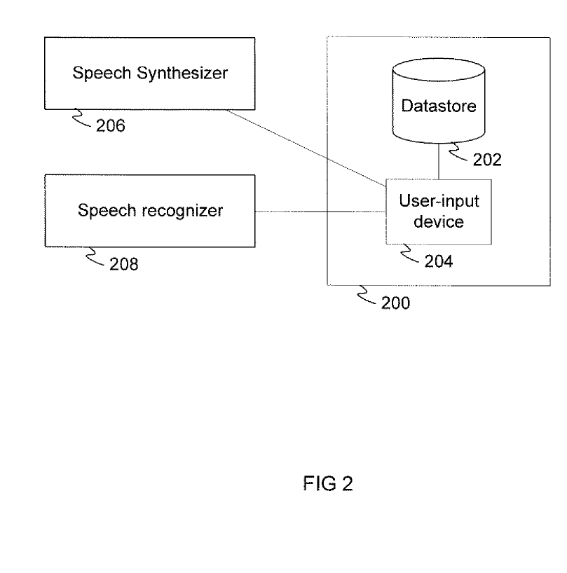

FIG. 2 depicts an example speech recognition system 200. The speech recognition system may include a datastore 202 in connection with a user interface 204. The datastore 202 may be any device, system, or subsystem suitable for storing data. For example, the datastore 202 may include system memory 121, ROM 124, RAM 125, flash storage, magnetic storage, storage area network (SAN), and the like.

The user interface 204 may include any system or subsystem suitable for presenting information to a user and receiving information from the user. In one embodiment, the user interface 204 may be a monitor in combination with a keyboard and mouse. In another embodiment, user interface 204 may include a touch-screen. For example, a personal digital assistant with touch screen and stylus may be used. For example, a tablet PC with touch screen and stylus may be used.

In one embodiment, the user interface 204 may be part of the computer 120. For example, the user interface 204 may be a graphical user interface. Also for example, the user interface 204 may include a graphical user interface as part of a computer operating system.

In one embodiment, the user interface 204 may include a switches, joysticks, trackballs, infrared control, motion or gesture sensors, and the like for receiving input from the user.

The user interface 204 may be in communication with a speech synthesizer 206. The speech synthesizer 206 may be any software, hardware, system, or subsystem suitable for synthesizing audible human speech. For example, the speech synthesizer 206 may include a text-to-speech (TTS) system. For example, the TTS may convert digital text into audible speech.

For example, the speech synthesizer 206 may include concatenative synthesis, formant synthesis technology, and the like. In one embodiment the speech synthesizer 206 may include a vocal model to create a synthetic voice output. In another embodiment, the speech synthesizer 206 may include segments of stored recorded speech. The segments may be concatenated and audibly played to produce human speech.

The user interface 204 may be in communication with a speech recognizer 208. The speech recognizer 208 may be any hardware, software, combination thereof, system, or subsystem suitable for discerning a word from a speech signal. For example, the speech recognizer 208 may receive a speech signal and process it. The processing may, for example, include hidden Markov model-based recognition, neural network-based recognition, dynamic time warping-based recognition, knowledge-based recognition, and the like.

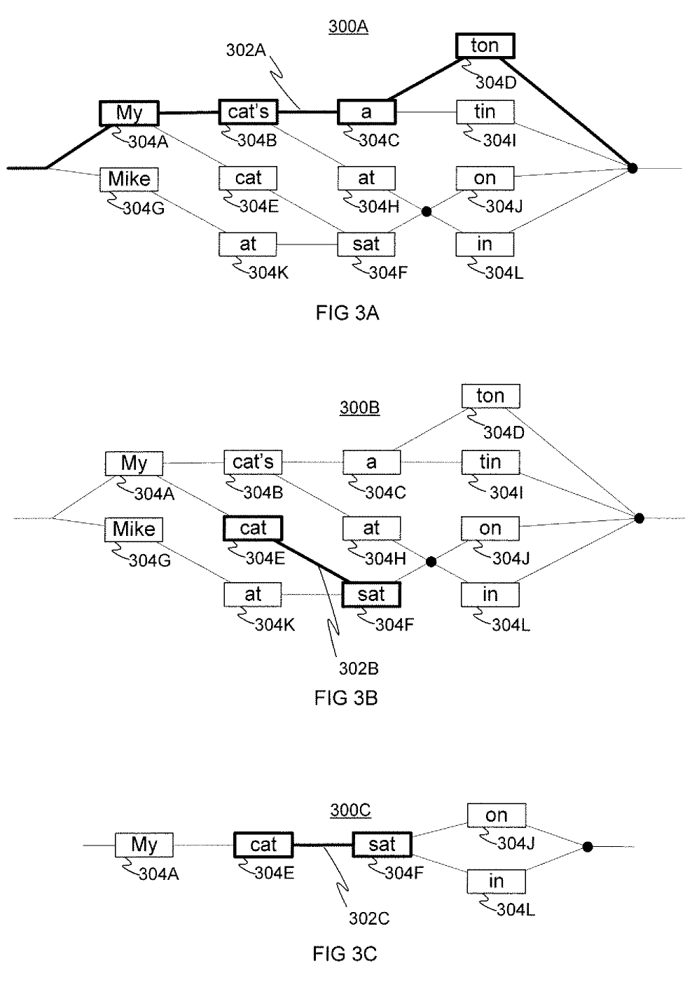

The user interface 204 may be adapted to display a graphical representation of a lattice of candidate words and to receive a selection of a path in the lattice (See FIG. 3). The datastore 202 may be adapted to store the selection. The source of the speech and the source of the selection may vary by application and implementation.

In one embodiment, a voice-based user may communicate with a text-based user. For example, the voice-based user may attempt to communicate with the text-based user over a public switched telephone network (PSTN), a voice over internet protocol network (VoIP), or the like. For example, the text-based user may attempt to communicate with the voice-based user over a text-based technology such as e-mail, instant messaging, internet relay chat, really simple syndication (RSS), and the like. Also for example, where the text-based user communicates via instant messaging, the text-based user may receive the lattice within an instant messaging protocol.

The voice-based user's call may be connected to the speech recognizer 208 and the speech synthesizer 206. For example, the voice-based user's call may be connected to an interactive voice response (IVR) unit. The speech recognizer 208 may receive audible speech from the voice-based user. The speech recognizer 208 may determine words that likely correspond to the audible speech and generate a lattice. The lattice may be displayed to the text-based user at the user interface 204.

When the text-based user understands from the lattice the message being communicated from the voice-based user, the text-based user may enter a text-based response. The text-based response may be received by the speech synthesizer 206 and audibly played to the voice-based user.

The text-based user may view the lattice and may select a path of the lattice. The path may represent all of the recognized speech or part of the recognized speech. The text-based user may select a path that corresponds with the text-based user's understanding of what the voice-based user is attempting to communicate. For example, the text-based user may leverage background, experience, understanding, context and the like to select a best path from the lattice.

In one embodiment, data indicative of the text-based user's selection may be sent to the speech synthesizer 206. The speech synthesizer 206 may be programmed to prompt the voice-based user to confirm the text-based user's selection. For example, where the text-based user selected a path corresponding to the words “let's meet at nine p.m.,” the speech synthesizer 206 may audibly play to the voice-based user synthesized speech stating, “did you say ‘let's meet at nine p.m.?’” In response to this prompt, the voice-based user may say “yes” or “no.” In another embodiment, the speech synthesizer 206 may also request that the voice-based user indicate “yes” or “no” via a dual tone multi-frequency response. For example, the speech synthesizer 206 may audibly play to the voice-based user synthesized speech stating, “did you say ‘let's meet at nine p.m.?’Press one for ‘ yes’ or two for ‘no.’”

If the voice-based user indicates that the selection is correct, this may be indicated to the text-based user. For example, the text-based user may receive verification of the selected path. Also for example, a confirmation may be displayed to the text-based user. In one embodiment, where the voice-based user indicates that the selection is correct, the selection may be sent to the speech recognizer 208 as positive feedback. The speech recognizer 208 may be able to further train the speech model and maintain a profile associated with the voice-based user.

If the voice-based user indicates that the selection is incorrect, this may be indicated to the text-based user. As a result, the text-based user may understand that another path is more likely and may respond appropriately within the context of the conversation. For example, the text-based user may have had two likely paths and getting a negative indication of one may indirectly mean that the other is likely to be correct. Alternatively, the text-based user may select another path to be confirmed by the voice-based user.

In one embodiment, a dictating user may be dictating and correcting speech. The dictating user may view the user interface 204. The dictating user may speak to the speech recognizer 208 to capture and convert spoken, audible speech. The speech recognizer 208 may send a lattice to the user interface 204, and the user interface 204 may display the lattice corresponding to the dictating user. The dictating user may select a path within the lattice to indicate that the path corresponds to the speech.

For example, the dictating user may speak an utterance. The dictating user may be presented with the lattice that represents all or some likely possibilities of words or phases that may correspond to the utterance. Also for example, the user interface 204 may display the most likely recognized words, and where the dictating user indicates that there has been a discrepancy between what has been spoken and what has been recognized, user interface 204 may display the lattice.

The dictating user may select one of the paths of the lattice as corresponding to the utterance. The dictating user may indicate a selection by movement of a user input device across a number of positions. Each position may correspond to a portion of the lattice. The selection made by the dictating user may be stored in the datastore 202. In one embodiment, the selection made by the dictating user may be provided as positive feedback to the speech recognizer 208.

In one embodiment, a transcribing user may review previously recognized speech for discrepancies between a text transcript and recorded, audible speech. The recorded, audible speech may represent input to the speech recognizer 208. The transcript may represent the most likely text that corresponds to the recorded, audible speech as determined by the speech recognizer 208. By viewing the text, the transcribing user may verify the recognized speech. For example, the transcribing user may read the transcript for errors.

Where the transcribing user recognizes a potential problem in the transcript, the transcribing user indicate the one or more potentially problematic words via the user interface 204. The user interface 204 may display a lattice corresponding to the one or more problematic words. The transcribing user may select a path in the lattice. Responsive to the transcribing user's selection, the user interface 204 may retrieve from the data store the corresponding recognizer input. The user interface 204 may play the corresponding recognizer input to the transcribing user. The transcribing user may listen to the audible speech and may select the path that correctly corresponds with the audible speech. In the alternative, the transcribing user may input new text that corresponds to the audible speech.

FIGS. 3A, B, C depict example lattices 300A, B, C and example paths 302A, B, C. The input to the speech recognizer 208 may be audible, human speech. This input may comprise a series of utterances. In one embodiment, the output of the speech recognizer 208 may be the lattice. In one embodiment, the output of the speech recognizer 208 may be formatted according to the lattice. The lattice may represent possible text associated with the recognizer input. The lattice may include connected candidate words 304A-L. The lattice may include words and phrases that, according the speech recognition algorithm of the speech recognizer 208, may likely correspond to the recognizer input. The lattice may include a relationship between words that may indicate the temporal proximity of their corresponding utterances. For example, two words that are directly joined in the lattice may correspond to two utterances that are proximate in time. The lattice may include the one or more candidate words corresponding to the same utterance as, for example, 304J and 304L.

The lattice may include one or more paths 302A, B, C. A path 302A, B, C may include at least one of the candidate words. The path 302A, B, C may represent a collection of temporally serial candidate words connected though the lattice. A path may span the lattice, as in path 302A. A path may span a portion of the lattice, as in 302B and 302C. In one embodiment, the lattice may include all recognized candidate words from the speech recognizer 208. For example, a listing of all the paths 302A, B, C of a lattice that includes all recognized candidate words 304A-L from the speech recognizer 208 may include all possible combinations of recognized text as determined from the speech recognizer 208. In one embodiment, the lattice may include recognized candidate words that, either jointly or independently, exceed a probability threshold. In one embodiment, the lattice may include an indication of a most likely path as determined by the speech recognizer 208. In one embodiment, the user interface 204 may display a most likely path in a way distinguishable from other paths. For example, the most likely path may be presented in bold, in color, flashing, highlighted, and the like.

To illustrate, an example input to a speech recognizer 208 may be the spoken input series of utterances, “my cat's a ton.” The input, as received by a speech recognizer 208, may result in a number of possible interpretations. For example, for the utterance associated with the word “ton,” the speech recognizer 208 may consider “ton” and “tin” as word candidates for that utterance. Thus, with such a process by the speech recognizer 208, an alternative for “my cat's a ton” may be “my cat's a tin.”

The candidate word “a” 304C may correspond to a first utterance received by the speech recognizer 208. The candidate words “ton” 304D and “tin” 304I may correspond to a second utterance in the input phase. The candidate word that corresponds to the first utterance may be joined in the lattice to the second candidate word and may be joined in the lattice to the third candidate word. For example, the candidate word “ton” 304D may be directly joined in the lattice to the candidate word “a” 304C. Also for example, the candidate word “tin” 304I may be directly joined in the lattice to the candidate word “a” 304C. The lattice as displayed to the user via the user interface 204 may indicate to the user that the speech recognizer 208 has indicated that the candidate word “ton” 304D and candidate word “tin” 304I are possible words that may correspond to a portion of the input phrase.

The input to the speech recognizer 208, “my cat's a ton” may include other candidate words 304A-L as determined by the speech recognizer 208. The lattice may include paths that represent the following:

My cat's a ton (304A, B, C, D)

My cat's a tin (304A, B, C, I)

My cat's at on (304A, B, H, J)

My cat's at in (304A, B, H, L)

My cat sat on (304A, E, F, J)

My cat sat in (304A, E, F, L)

Mike at sat on (304G, K, F, J)

Mike at sat in (304G, K, F, L)

In the lattice, redundancies associated with the possible recognizer outputs may be reduced as displayed to the user.

A user may select a path of the lattice that corresponds to the spoken speech. For example, a user may select a first path 302A (indicated in bold) that represents an entire phrase as shown in FIG. 3A. The first path 302A may correspond to the candidate words 304A, B, C, and D. Also for example, a user may select a second path 302B that represents a portion of the uttered phrase as shown in FIG. 3B. The second path 302B may correspond to the candidate words 304E, F.

Responsive to the user selecting a path, the system may be able to determine that other paths in the lattice may be inconsistent with the selected path. Such inconsistent paths may be cleared from the lattice and be removed from display to the user. For example, where the user is not sure whether the recognizer input corresponds to the phrase “my cat sat on” or “my cat sat in,” the user may select path 302B that includes the candidate words “cat sat” 304E, F. Responsive to the user selecting the path 302B, the system may determine and clear other paths inconsistent with the selection. For example, paths through the lattice not including the selected path 302B may be cleared. For example, any path that includes the candidate word “cat's” 304B or the candidate word “at” 304H may be cleared. The lattice 300C may be collapsed responsive to selecting the path 302B such that only the paths relating to “my cat sat on” and “my cat sat in” remain, as shown in FIG. 3C.

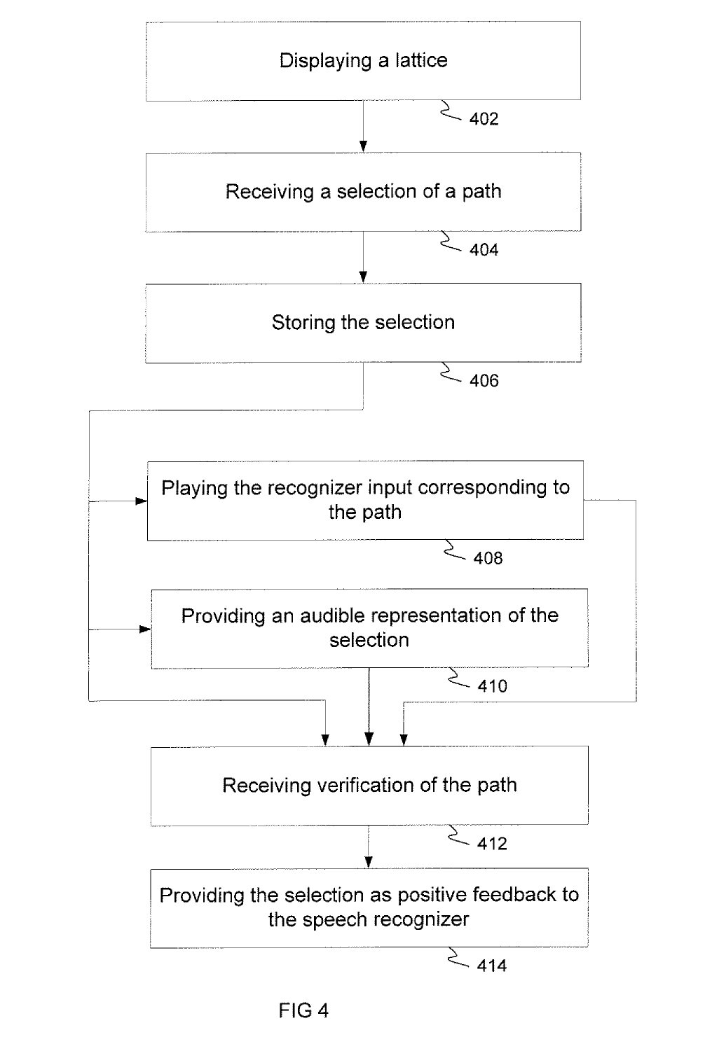

FIG. 4 depicts a process flow diagram for interacting with a speech recognition system. At 402, a lattice of candidate words may be displayed to a user. The lattice may include the output of the speech recognizer 208. The speech recognizer 208 may receive as input a plurality of utterances. A second utterance may be temporally proximate to a first utterance. The lattice of candidate words may include one or more first candidate words that correspond to the first utterance received by the speech recognizer 208. Within the lattice the first candidate words may be joined to one or more second candidate words. The second candidate words may each correspond to a second utterance received by the speech recognizer 208.

At 404, the user interface 204 may receive a selection of a path in the lattice. The selected path may comprise at least one of the candidate words. Paths inconsistent with the selection may be cleared from the lattice and removed from the display. The selection may be provided to the speech recognizer 208 as positive feedback for the purpose of training the speech recognizer 208. The user may select a path by moving a user input device to a plurality of positions. The plurality of positions may correspond to a path in the lattice. For example, where the lattice may be displayed on a touch-screen, the path may be represented by a plurality of positions, each position associated with a candidate word in the path. The user may select a path by engaging the touch-screen along selected positions.

At 406 the selection may be stored in the datastore 202. In one embodiment, storing the selection may include data that indexes the selection to a segment of recognizer input. In one embodiment, the selection may be stored with an associated segment of the recognizer input. In one embodiment, the selection may be stored by storing the text associated with the selection. For example, storing a selection may include storing the words of a selected path in the transcript. For example where a user is correcting the transcript, selecting a path may result in corresponding candidate words being populated into a corresponding section of the transcript.

At 408, the user-interface may retrieve the recognizer input and may audibly play the recognizer input that corresponds with the selection. For example, the user-interface 204 may include audio capabilities and the recognizer input may be played audibly via the user interface 204.

At 410, an audible representation of the selection may be provided. For example, the selection may be processed by a text-to-speech engine. The text-to-speech engine may render an audible representation of the selection. In one embodiment, the audible representation may be provided in the context of a verification prompt. The user may be prompted verify that the selected path corresponds to the spoken words. The text-to-speech engine renders an audible representation of the text-based users selected path to the voice-based user who is then prompted to verify that the rendered selection corresponds to spoken words.

At 412, the speech recognition system may receive verification of a selected path. In one embodiment, the verification of the path may be provided by a voice-based user responsive to the audible representation of the selection and the verification prompt. In one embodiment, the verification may be provided by a transcribing user responsive to the playing of the recognizer input corresponding to the path. In one embodiment, a dictating user may provide verification of the path that corresponds the dictating user's speech. The verification may be indicated via the user interface 204.

At 412, the selection may be provided as positive feedback to a speech recognizer 208. For example, where the speech recognizer 208 user a hidden Markov model for speech recognizing, the selection may be used in a maximum likelihood (ML) criterion, maximum mutual information (MMI) criterion, and the like.

To a useful and tangible end, the embodiments described above may provide increased efficiency and accuracy of speech recognition systems by providing a compact and efficient way of providing feedback. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for interacting with a speech recognition system, the method comprising:
displaying a lattice of candidate words;
receiving a selection of a path in the lattice, the path comprising at least one of the candidate words; and
storing the selection.

2. The method of claim 1, wherein the lattice of candidate words comprises output of a speech recognizer.

3. The method of claim 2, wherein the lattice of candidate words comprises a first candidate word corresponding to a first utterance received by the speech recognizer, the first candidate word being joined in the lattice to a second candidate word and to a third candidate word, the second and third candidate words each corresponding to a second utterance received by the speech recognizer.

4. The method of claim 3, wherein selected path comprises the second candidate word, and further comprising clearing the third candidate word from the lattice.

5. The method of claim 2, further comprising providing the selection as positive feedback to the speech recognizer.

6. The method of claim 2, further comprising playing the recognizer input corresponding to the path.

7. The method of claim 1, further comprising providing an audible representation of the selection.

8. The method of claim 7, further comprising receiving verification of the selected path.

9. The method of claim 1, wherein storing comprises storing the selected path in a transcript.

10. The method of claim 1, wherein the selection comprises a movement of a user-input device to a plurality of positions, each position corresponding to the path in the lattice.

11. The method of claim 1, further comprising receiving the lattice in an instant messaging protocol.

12. A speech recognition system comprising:
a user interface adapted to display a graphical representation of a lattice of candidate words and to receive a selection of a path in the lattice; and
a datastore adapted to store the selection.

13. The system of claim 12, wherein the lattice of candidate words comprises output from a speech recognizer.

14. The system of claim 13, wherein the lattice of candidate words comprises a first candidate word corresponding to a first utterance received by the speech recognizer, the first candidate word being joined in the lattice to a second candidate word and to a third candidate word, the second and third candidate words each corresponding to a second utterance received by the speech recognizer.

15. The system of claim 12, further comprising a user-input device in communication with the processor, wherein the selection of a path comprises movement of the user-input device to a plurality of positions, each position corresponding to the path in the lattice.

16. The system of claim 12, further comprising an output that provides the selection to a text-to-speech engine.

17. A computer readable storage medium for interacting with a speech recognition system, the speech recognition system receiving an utterance, the computer readable storage medium including computer executable instructions to perform the acts comprising:
displaying a lattice of candidate words;
receiving a selection of a path in the lattice, the path comprising at least one of the candidate words; and
providing the path for confirmation that the path corresponds to the utterance.

18. The computer readable storage medium of claim 17, wherein the path comprises at least a candidate word and providing the path for confirmation comprises providing the candidate word to a text-to-speech engine.

19. The computer readable storage medium of claim 17, wherein the computer executable instructions perform the acts further comprising:
receiving the lattice in an instant messaging protocol.

20. The computer readable storage medium of claim 17, wherein the computer executable instructions perform the acts further comprising:
providing the selection as positive feedback to the speech recognition system.
